(19) United States
(12) Patent Application Publication
(10) Pub. No.: US 2007/0153099 A1
(43) Pub. Date: Jul. 5, 2007

(54) Image signal processing apparatus, imaging apparatus, image signal processing method and computer program thereof

(76) Inventors: Mitsuharu Ohki, Tokyo (JP); Tomoo Mitsunaga, Kanagawa (JP); Shinichi Yoshimura, Tokyo (JP); Masanori Kasai, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/640,252

(22) Filed: Dec. 18, 2006

(30) Foreign Application Priority Data
Dec. 22, 2005 (JP) 2005-369379

(51) Int. Cl. H04N 9/68

(52) U.S. Cl. 348/234

(57) ABSTRACT

There is provided an image signal processing apparatus having a luminance signal producing unit which receives input of a mosaic image of a signal acquired by a wide wavelength range signal acquisition element from signals acquired by a single-plate imaging device having element arrays including a specific wavelength range signal acquisition element for acquiring a visible light signal corresponding to a specific light wavelength range and the wide wavelength range signal acquisition element for acquiring a light signal containing a visible light component and an invisible light component, and produces, as a luminance signal, a wide wavelength range signal demosaic image; and a color difference signal producing unit which receives input of a mosaic image of a signal acquired by the specific wavelength range signal acquisition element, produces a visible light range signal demosaic image, and produces a color difference signal based on the visible light range signal demosaic image.

### BACKGROUND OF THE INVENTION

1. Field of the Invention

The present invention relates to an image signal processing apparatus, an imaging apparatus, an image signal processing method and a computer program, and more particularly to an image signal processing apparatus, an imaging apparatus, an image signal processing method and a computer program for performing signal processing of imaged data by a solid state imaging device of a single plate color system.

2. Description of Related Art

A general solid state imaging device of the single plate color system has a color filter stuck thereto to transmit a specific wavelength component in each pixel to a surface of an imaging device, and restores necessary color components by a set of a plurality of pixels. At this time, for example, a color array expressing red (R), green (G) and blue (B) by a set of four pixels as shown in FIG. 1A or an array in which white (Y) as a luminance signal is combined with red (R), green (G) and blue (B) as shown in FIG. 1B is used as the color array used for the color filter. Both of these are called the Bayer color array. Because each pixel has only the information of a single color component like this in the solid state imaging device of the single plate color system, demosaic processing that restores necessary color components in each pixel by performing interpolation processing using the color information of surrounding pixels is performed.

The configuration of an imaging apparatus equipped with a solid state imaging device of the single plate color system is shown in FIG. 2. A solid state imaging device 13 of the single plate color system receives the light that transmits a color filter 12 among the incident light-through an optical lens 11. An image signal that is photoelectrically converted by the solid state imaging device 13 to be output as an electric signal is converted into a digital signal by a not shown A/D converter. After that, the converted image signal receives clipping processing, gamma correction, white balance correction, demosaic processing and the like in a camera signal processing unit 14, and the processed signal is transmitted to an image compressing unit 15. The image compressing unit 15 reduces the amount of data of the image signal, and converts the reduced image signal into a predetermined recording image format to output the converted image signal. A recording unit 16 records the converted image data on a recording medium. Hereupon, it is not always necessary to perform the image compressing processing, the image compression is ordinarily performed because the number of pixels of an imaging device has increased in recent years and the miniaturization of an apparatus itself has been required.

With reference to FIG. 3, the demosaic processing of an image obtained by the solid state imaging device of a single plate color system is described. The solid state imaging device of a single plate color system is configured to perform imaging through a color filter having a color array such as the Bayer color array of the primary color system (see FIG. 1) or the like, and is configured to obtain only the signals having a specific wavelength to each pixel, i.e., the color component data of a specific wavelength. In a case of using the solid state imaging device of the single plate color system having the Bayer color array, an output image 20 of the solid state imaging device becomes a color mosaic image having only one piece of information of R, G and B at each pixel.

A demosaic processing unit 21 executes the processing of restoring all pieces of information of each color component data, i.e., R, G and B, by performing color interpolation processing to each pixel.

First, the restoration of a G signal which restoration is executed by the demosaic processing unit 21 is described. In the Bayer color array shown in FIG. 1A, the G signal is obtained in a checkered pattern. At a pixel at which no G signal exists in the output image 20 of the solid state imaging device, for example, a case of G₁₁, the G signal is generated by interpolation processing based on surrounding G signals. To put it concretely, the G signal (G₁₁) is restored in accordance with the following expression.
G₁₁=(¼)(G_{01,} +G₂₁ +G₁₀ +G₁₂)

Next, the restorations of an R signal and a B signal are described. In the Bayer color array as shown in FIG. 1A, the data of both of the R and B exist every other pixel line. For example, R signals exist but no B signals exist in the pixel line of the top rung of the output image. 20 of the solid state imaging device shown in FIG. 3. Moreover, B signals exist but no R signals exist in the second pixel-line.

In a pixel line in which either data R or data B exists, the data R or the data B is obtained every other pixel. In the case where an R signal (B signal) exists in the same line as that of a pixel at which a certain R signal (B signal) does not exist in the output image 20 of the solid state imaging device, for example, cases of R₀₁ and B₁₂, interpolated pixel values in the pixels in which the R and B signals do not exist on the pixel line can be calculated by the following expressions, and the R signal (B signal) of each pixel can be restored.
R₀₁ =(½)(R₀₀+R₀₂)
B₁₂ =(½)(B₁₁ +B₁₃)

In the case where R signals (B signals) exist in the same column, for example, cases of R₁₀and B₂₁, the interpolated pixel values at the pixels where certain R and B signals do not exist can be similarly calculated in accordance with the following expressions, and the R signal (B signal) in each pixel is restored.
R₁₀ =(½)(R₀₀ +R₂₀)
B₂₁ =(½)(B₁₁,+B₃₁)

Moreover, in a case where no R signals (B signals) exist in both of the same line and the same column, for example, cases of R₁₁ and B₂₂, the interpolated pixel values in the pixels in which certain R and B signals exist can be calculated by the following expressions, and the R signal (B signal) at each pixel is restored.
R₁₁ =(¼)(R₀₀ +R₀₂ +R₂₀ +R₂₂)
B₂₂ =(¼)(B₁₁ +B₁₃ +B₃₁ +B₃₃)

The demosaic processing unit 21 performs the color interpolation processing as mentioned above, and outputs R signals 22r, G signals 22g and B signals 22b to all pixels. It is noted that the above interpolation processing is only one example, and any color interpolation processing using the correlations with the other color signals may be performed.

An improvement of image quality of images captured with a digital still camera or a movie camera in a low illumination condition has become an important issue. In a case of capturing images in a low illumination condition, it is generally practiced to decrease a shutter speed, utilize a lens having a brighter value of aperture, and/or apply an external visible light source such as flash.

In this case, decreased shutter speed results in a camera shake and image blurring. Also, as to the aperture value of lens, there is normally a limit; therefore it is difficult to make it brighter than a certain limit. Further, when an external visible light source is used, there is a problem that an illumination environment of scene or feel of ambient illumination is degraded by flash.

Most of the low illumination conditions are brought by a light source having a low color temperature and plentiful radiant quantities of infrareds is used in most cases. In addition, if an invisible light such as infrared light is used as an auxiliary lighting, the environment of scene is less degraded. In consideration of the above, a technique to be able to improve effective imaging sensitivity under a light source which contains a plenty of invisible light such as an infrared light is greatly desired.

For example, in Japanese Patent Application Publication No. Hei 4-88784 (Patent Document 1), a signal processing method is disclosed for obtaining a high resolution image by use of an imaging device (imager) which applies the color arrays, i.e., the Bayer array combining white color (Y) as the luminance signal together with red (R), green (G) and blue (B) colors as described above by referring to FIG. 1B. Patent Document 1 describes a signal processing method capable of obtaining an improved resolution by utilizing these white pixels disposed in the checkered pattern on the assumption of every pixel being insensitive to an infrared light by applying color filter arrays with white pixels disposed in a checkered pattern as shown in FIG. 1B.

That is, according to the arrays shown in FIG. 1B, because Y pixels arrayed in the checkered pattern has sensitivity to almost all of visible light, it is possible to obtain a larger signal than with green (G) pixels arrayed in checkered pattern as shown in FIG. 1A. Therefore, it can be understood that an S/N ratio which determines image resolution can be improved in comparison with the case of the green pixels arrayed in the checkered pattern.

Such color arrays as shown in FIG. 1B may be effective if a sufficient lighting is provided, however, when a sufficient lighting is not provided such as in darkness, or in a low illumination condition although its light source contains much of infrared light, or in a capturing condition with a low illumination with an auxiliary light source of infrared being used, there remains a problem that sensitivity is still insufficient thereby prohibiting to produce a high quality image with reduced noise.

### SUMMARY OF THE INVENTION

The present invention is contemplated to provide an image signal processing apparatus, an imaging apparatus, an image signal processing method and a computer program thereof, capable of producing a high-quality image data with reduced noise even for such images to be captured with a single-plate color solid-state imager under an insufficient illumination such as in the darkness, in a low illumination condition with its light source containing much of an infrared light, or in a low illumination using an auxiliary light of infrared.

An image signal processing apparatus according to an embodiment of the present invention includes a luminance signal producing unit and a color difference signal producing unit. The luminance signal producing unit receives input of a first mosaic image from signals acquired by a single-plate color imager and produces, as a luminance signal, a wide wavelength range signal demosaic image corresponding to a wide wavelength range signal. The single-plate color imager has element arrays configured with a specific wavelength range signal acquisition element for acquiring a visible light signal corresponding to a specific light wavelength range and a wide wavelength range signal acquisition element for acquiring a light signal including a visible light component and an invisible light component. The first mosaic image is a signal acquired by the wide wavelength range signal acquisition element. The color difference signal producing unit receives input of a second mosaic image which is a signal acquired by the specific wavelength range signal acquisition element, produces a visible light range signal demosaic image corresponding to a visible light range signal, and produces a color difference signal based on the visible light range signal demosaic image.

Further, in the image signal processing apparatus, according to another embodiment of the present invention, the specific wavelength range signal acquisition element is an RGB-element for separately acquiring a color component signal RGB, and the wide wavelength range signal acquisition element is an A-element for acquiring an A-signal containing an RGB-color signal component and an infrared light component. The luminance signal producing unit is configured to receive input of an A-mosaic image which is a signal acquired by the A-element for acquiring the A-signal and execute a processing to produce as a luminance signal an A-signal demosaic image containing the RGB-color signal component and the infrared light component. The color difference signal producing unit is configured to receive input of an RGB-mosaic image which is a signal acquired by the RGB-element, produces an RGB-demosaic image, and produces a color difference signal based on the RGB-demosaic image.

Further, in the image signal processing apparatus, according to one embodiment of the invention, the color difference signal producing unit is configured to execute a process to produce color difference signals R-Y and B-Y based on the RGB-demosaic image.

Still further, an image signal processing apparatus according to an embodiment of the present invention includes a first color component-signal extraction unit, a second color component signal extraction unit, and a synthesizing process unit. The first color component signal extraction unit receives input of a first mosaic image from signals acquired by a single-plate imager and extracts a first color component signal from a wide wavelength range signal demosaic image. The single-plate imager has element arrays including a specific wavelength range signal acquisition element for acquiring a visible light signal corresponding to a specific light wavelength range and a wide wavelength range signal acquisition element for acquiring a light signal containing a visible light component and an invisible light component. The first mosaic image is a signal acquired by the wide wavelength range signal acquisition element. The first color component signal is a visible light color component signal. The second color component signal extraction unit receives input of a second mosaic image, produces a visible light range signal demosaic image and extracts a second color component signal based on the visible light range signal demosaic image. The second demosaic image is a signal acquired by the specific wavelength range signal acquisition element. The visible light range signal demosaic image corresponds to a visible light range signal. The synthesizing process unit synthesizes the first color component signal and the second color component signal.

Furthermore, in the image signal processing apparatus, according to one embodiment of the present invention, the first color component signal extraction unit is configured to have a wide wavelength range signal demosaic image producing unit, a wide wavelength range signal high frequency component image producing unit, and a visible light color component signal extraction unit. The wide wavelength range signal demosaic image producing unit receives input of a mosaic image of a signal acquired by the wide wavelength range signal acquisition element, and produces a wide wavelength range signal demosaic image corresponding to a wide wavelength range signal. The wide wavelength range signal high frequency component image producing unit extracts a high frequency component from the wide wavelength range signal demosaic image, and produces a wide wavelength range signal-high frequency component image. The visible light color component signal extraction unit extracts a visible light color component signal based on the wide wavelength range signal high frequency component image.

Still furthermore, in the image signal processing apparatus, according to one embodiment of the present invention, the specific wavelength range signal acquisition element is an RGB-element for separately acquiring a color component signal RGB, and the wide wavelength range signal acquisition element is an A-element for acquiring an A signal which contains an RGB-color signal component and an infrared light component. The first color component signal extraction unit is configured to receive input of a mosaic image which is a signal acquired by the A-element and extract a visible light color component signal RGB from an A-signal demosaic image. The second color component signal extraction unit is configured to receive input of an RGB-mosaic image which is a signal acquired by the RGB-element, produce an RGB-demosaic image, and extract a color component signal RGB based on the RGB-demosaic image. The synthesizing process unit is configured to synthesize the visible light color component signal RGB extracted in the first color component extraction unit and the color component signal RGB extracted in the second color component extraction unit.

An imager according to an embodiment of the present invention is an imager having element arrays including a specific wavelength range signal acquisition element for acquiring a visible light signal corresponding to a specific light wavelength range, and a wide wavelength range signal acquisition element for acquiring a light signal containing a visible light component and an invisible light component.

Furthermore, in the imager according to an embodiment of the present invention, the specific wavelength range signal acquisition element is an RGB-element for separately acquiring a color component signal RGB, and the wide wavelength range signal acquisition element is an A-element for acquiring an A-signal which contains an RGB-color signal component and an infrared light component.

Still further, in the imager, according to one embodiment of the invention, the wide wavelength range signal acquisition element A is configured to be disposed in a checkered pattern.

An imaging apparatus according to an embodiment of the present invention includes a single-plate imager, a luminance signal producing unit, and a color difference signal producing unit. The single-plate imager has element arrays including a specific wavelength range signal acquisition element for acquiring a visible light signal corresponding to a specific light wavelength range and a wide wavelength range signal acquisition element for acquiring a light signal containing a visible light component and an invisible light component. The luminance signal producing unit receives input of a mosaic image which is a signal acquired by the wide wavelength range signal acquisition element from a plurality of signals acquired by the single-plate imager, and produces, as a luminance signal, a wide wavelength range signal demosaic image corresponding to the wide wavelength range signal. The color difference signal producing unit receives input of a mosaic image of a signal acquired by the specific wavelength range signal acquisition element, produces a visible light range signal demosaic image corresponding to a visible light range signal, and produces a color difference signal based on the visible light range signal demosaic image.

In the imaging apparatus, according to one embodiment of the present invention, the specific wavelength range signal acquisition element is an RGB-element for separately acquiring a color component signal RGB, and the wide wavelength range signal acquisition element is an A-element for acquiring an A-signal containing RGB color signal components and an infrared light component. The luminance signal producing unit is configured to receive input of an-A mosaic image which is a signal acquired by the A-element for acquiring A-signals, and generates an A-demosaic image containing RGB color signal components and an infrared light component, as a luminance signal. The color difference signal producing unit is configured to receive input of an RGB-mosaic image which is a signal acquired by the RGB element, produce an RGB-demosaic image, and generate a color difference signal based on the RGB demosaic image.

Further, in the imaging apparatus according to one embodiment of the invention, the color difference signal producing unit is configured to perform processing to produce color difference signals R-Y and B-Y on the basis of the RGB demosaic image.

An imaging apparatus according to an embodiment of the present invention includes a single-plate imager, a first color component signal extraction unit, a second color component signal extraction unit, and a synthesizing unit. The single-plate imager has element arrays including a specific wavelength range signal acquisition element for acquiring a visible light signal corresponding to a specific light wavelength range and a wide wavelength range signal acquisition element for acquiring a light signal containing a visible light component and an invisible light component. The first color component signal extraction unit receives input of a mosaic image which is a signal acquired by the wide wavelength range signal acquisition element from a plurality of signals acquired by the single-plate imager, and extracts a visible light color component signal from a wide wavelength range signal demosaic image corresponding to a wide wavelength range signal. The second color component signal extraction unit receives input of a mosaic image which is a signal acquired by the specific wavelength range signal acquisition element, produces a visible light range signal demosaic image corresponding to a visible light range signal, and extracts a color component signal based on the visible light range signal demosaic image. The synthesizing unit synthesizes a color component signal extracted in the first color component extraction unit and a color component signal extracted in the second color component extraction unit.

Further, in the imaging apparatus according to one embodiment of the present invention, the first color component signal extraction unit is configured to include a wide wavelength range signal demosaic image producing unit, a wide wavelength range signal high frequency component image generating unit, and a visible light color component signal extraction unit. The wide wavelength range signal demosaic image producing unit receives input of a mosaic image which is a signal acquired by the wide wavelength range signal acquisition element, and produces a wide wavelength range signal demosaic image corresponding to a wide wavelength range signal. The wide wavelength range signal high frequency component image generating unit extracts a high frequency component from the wide wavelength range signal demosaic image, and produces a wide wavelength range signal high frequency component image. The visible light color component signal extraction unit extracts a visible light color component signal from the wide wavelength range signal high frequency component image.

Still further, in the imaging apparatus according to one embodiment of the present invention, the specific wavelength range signal acquisition element is an RGB-element for separately acquiring a color component signal RGB, and the wide wavelength range signal acquisition element is an A-element for acquiring an A-signal containing RGB color signal components and an infrared light component. The first color component signal extraction unit is configured to receive input of a mosaic image which is a signal acquired by the A-element, and extract a visible light color component signal RGB from an A-signal demosaic image. The second color component signal extraction unit is configured to receive input of an RGB-mosaic image which is a signal acquired by the RGB-element, produce RGB-demosaic images, and extract a color component signal RGB based on the RGB-demosaic image. The synthesizing process unit is configured to perform a processing to synthesize a color component signal RGB extracted in the first color component extraction unit and a color component signal RGB extracted in the second color component extraction unit.

Further, an image signal processing method according to an embodiment of the present invention includes a luminance signal producing step, and color difference signal producing step. The luminance signal producing step is a step of inputting a mosaic image which is a signal acquired by a wide wavelength range signal acquisition element from signals acquired by a single-plate imager having element arrays including a specific wavelength range signal acquisition element which acquires a visible light signal corresponding to a specific light wavelength range and the wide wavelength range signal acquisition element which acquires a light signal containing a visible light component and an invisible light component, and producing a wide wavelength range signal demosaic image corresponding to a wide wavelength range signal as a luminance signal. The color difference signal producing step is a step of inputting a mosaic image which is a signal acquired by the specific wavelength range signal acquisition element, producing a visible light range signal demosaic image corresponding to a visible light range signal, and generating a color difference signal based on the visible light range signal demosaic image.

Further in the image signal processing method according to one embodiment of the present invention, the specific wavelength range signal acquisition element is an RGB-element for separately acquiring a color component signal RGB, the wide wavelength range signal acquisition element is an A-element for acquiring an A-signal containing RGB-color signal components and an infrared light component. The luminance signal generating step is a step of performing a processing to input an A-mosaic image which is a signal acquired by the A-element, and produce an A-signal demosaic image containing RGB-color components and an infrared light component as a luminance signal. The color difference signal forming step is a step of performing a processing to input an RGB-mosaic image signal acquired by the RGB element, produce an RGB-demosaic image, and generate a color difference signal based on the RGB demosaic images.

Still further, in the image signal processing method according to one embodiment of the present invention, the color difference signal generating step is a step of performing a processing to generate color difference signals R-Y and B-Y on the basis of the RGB demosaic image.

Furthermore, an image signal processing method according to an embodiment of the present invention includes a first color component signal extraction step, a second color component signal extraction-step, and a synthesizing step. The first color component signal extraction step is a step of inputting a mosaic image which is a signal acquired by a wide wavelength range signal acquisition element from a plurality of signals acquired by a single-plate imager having element arrays including a specific wavelength range signal acquisition element for acquiring a visible light signal corresponding to a specific light wavelength range and a wide wavelength range signal acquisition element for acquiring a light signal containing a visible light component and an invisible light component, and extracting a visible light color component signal from a wide wavelength range signal demosaic image corresponding to a wide wavelength range signal. The second color component signal extraction step is a step of inputting a mosaic image which is a signal acquired by the specific wavelength range signal acquisition element, generating a visible light range signal demosaic image corresponding to a visible light range signal, and extracting a color component signal on the basis of the visible light range signal demosaic image. The synthesizing step is a step of performing processing to synthesize a color component signal extracted in the first color component extraction step and a color component signal extracted in the second color component extraction step.

Furthermore, in the image signal processing method according to one embodiment of the present invention, the first color component signal extraction step includes a wide wavelength range signal demosaic image producing step, a wide wavelength range signal high frequency component image producing step, and a visible light color component signal extraction step. The wide wavelength range signal demosaic image producing step is a step of inputting a mosaic image which is a signal acquired by the wide wavelength range signal acquisition element, and producing a wide wavelength range signal demosaic image corresponding to a wide wavelength range signal. The wide wavelength range signal high frequency component image producing step is a step of extracting a high frequency component from the wide wavelength range signal demosaic image, and producing a wide wavelength range signal high frequency component image. The visible light color component signal extraction step is a step of extracting a visible light color component signal from the wide wavelength range signal high frequency component image.

In the image signal processing method according to one embodiment of the present invention, the specific wavelength range signal acquisition element is an RGB-element for separately acquiring a color component signal RGB, and the wide wavelength range signal acquisition element is an A-element for acquiring an A-signal which contains RGB color signal components and an infrared light component. The first color component signal extraction step is a step of performing processing to input a mosaic image which is a signal acquired by the A-element, and extract a visible light color component signal RGB from an A-signal demosaic image. The second color component signal extraction step is a step of performing processing to input an RGB-mosaic image acquired by the RGB-element, produce an RGB-demosaic image, and extract a color component signal RGB based on the RGB-demosaic image. The synthesizing process step is a step of performing processing to synthesize the color component signal RGB extracted in the first color component extraction step and the color component signal RGB extracted-in the second color component extraction step.

Furthermore, a computer program for enabling to execute an image signal processing in an image signal processing apparatus according to an embodiment of the present invention includes a luminance signal generating step, and a color difference signal generating step. The luminance signal generating step is a step of inputting a mosaic image of a signal acquired by a wide wavelength range signal-acquisition element from a plurality of signals acquired by a single-plate imager having element arrays including a specific wavelength range signal acquisition element corresponding to a specific light wavelength range and a wide wavelength range signal acquisition element for acquiring a light signal containing a visible light component and an invisible light component, and generating, as a luminance signal, a wide wavelength range signal demosaic image corresponding to a wide wavelength range signal. The color-difference signal generating step is a step of inputting a mosaic image of a signal acquired by the specific wavelength range signal acquisition element, producing a visible light range signal demosaic image corresponding to a visible light range signal, and generating a color difference signal based on the visible light range signal demosaic image.

A computer program enabling to execute an image signal processing in the image signal processing apparatus according to an embodiment of the present invention includes a first color component signal extracting step, a second color component signal extracting step, and a synthesizing step. The first color component signal extracting step is a step of inputting a mosaic image of a signal acquired by a wide wavelength range signal acquisition element from a plurality of signals acquired by a single-plate imager having element arrays including a specific wavelength range signal acquisition element for acquiring a visible light signal corresponding to a specific wavelength range and a wide wavelength range signal acquisition element for acquiring a light signal which contains a visible light component and an invisible light component, and extracting a visible light color component signal from a wide wavelength range signal demosaic image corresponding to a wide wavelength range signal. The second color component signal extracting step is a step of inputting a mosaic image signal acquired by the specific wavelength range signal acquisition element, producing a visible light range signal demosaic image corresponding to a visible light range signal, and extracting a color component signal based on the visible light range signal demosaic image. The synthesizing step is a step of performing a processing to synthesize a color component signal extracted in the first color component extracting step and a-color component signal extracted in the second color component extracting step.

By way of example, the computer program according to the embodiment of the present invention is a computer program to be supplied, for example, to a general purpose computer system capable of executing versatile programming codes, and in a computer readable format such as in a recording medium or communication medium, for example, in such recording media as a CD, FD, MO, or via communication media such as a network or the like. By providing the above program in a computer readable format as described above, an appropriate processing in accordance with the program can be realized in a computer system.

It is to be noted in the description of the present invention that the term of system refers to a logical combination or assembled configuration of several pieces of equipment to perform a specific function, and it is not limited for these pieces of equipment to be mounted in the same package.

### BRIEF DESCRIPTION OF THE DRAWINGS

FIG. 1 is a diagram showing an example of Bayer arrays for use as color arrays in a general color filter;

FIG. 2 is a block diagram showing a configuration of an imaging apparatus provided with a single-plate color solid-state imager;.

FIG. 3 is a diagram showing a demosaic process;

FIG. 4 is a diagram showing color arrays in the imager applied to an embodiment of the present invention;

FIG. 5 is a diagram showing optical transmittance of color filters in the imager applied to the embodiment of the present invention;

FIG. 6 is a diagram showing another pattern of color arrays in the imager applied to the embodiment of the present invention;

FIG. 7 is a block diagram showing an image signal processing apparatus (processing example 1) according to one embodiment of the present invention;

FIG. 8 is a diagram showing mosaic images and demosaic images to be produced in the processing according to the embodiment of the present invention;

FIG. 9 is a block diagram showing another image signal processing apparatus (processing example 2) according to another embodiment of the present invention; and

FIG. 10 is a diagram showing coefficients of high pass filters in the image signal processing apparatus (processing example 2) according to one embodiment of the invention.

### DESCRIPTION OF THE EMBODIMENTS

By referring to the accompanying drawings, an image signal processing apparatus, an imaging apparatus, an image signal processing method and a computer program thereof according to the present invention will be described more in detail in the sequential order as follows.
1. Configuration of Imager
2. First image signal processing example
3. Second image signal processing example
   [1. Configuration of Imager]

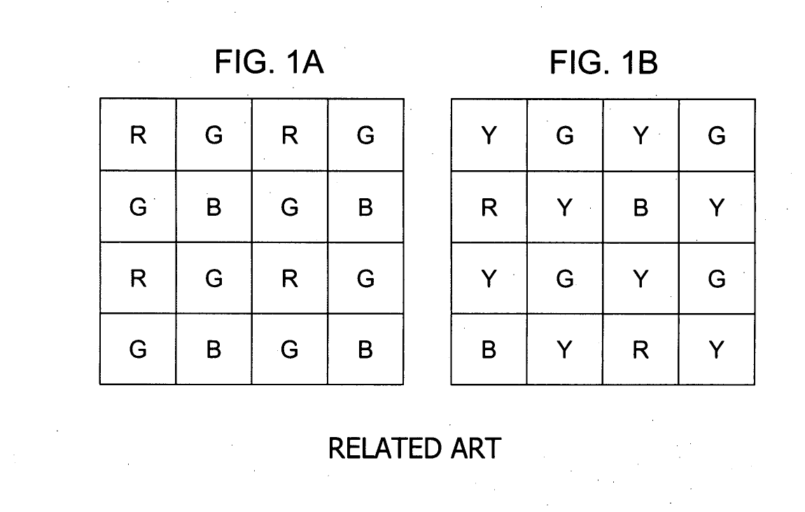

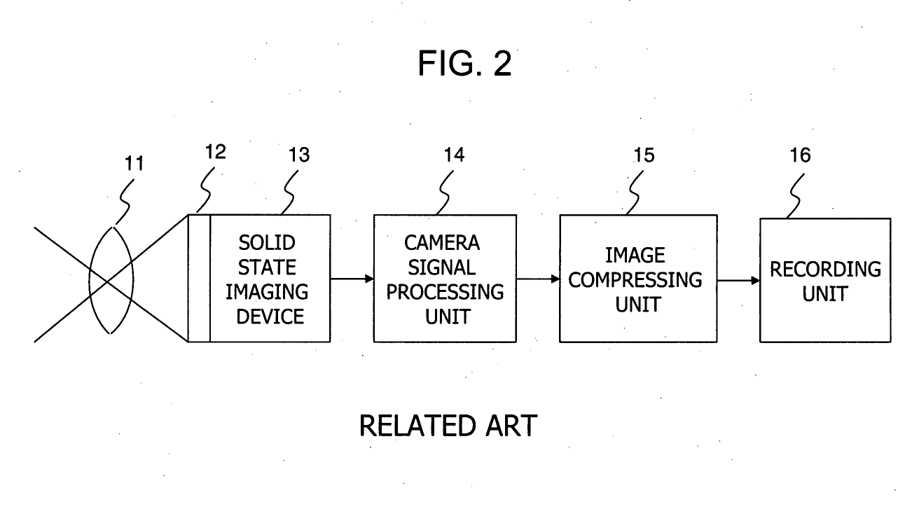

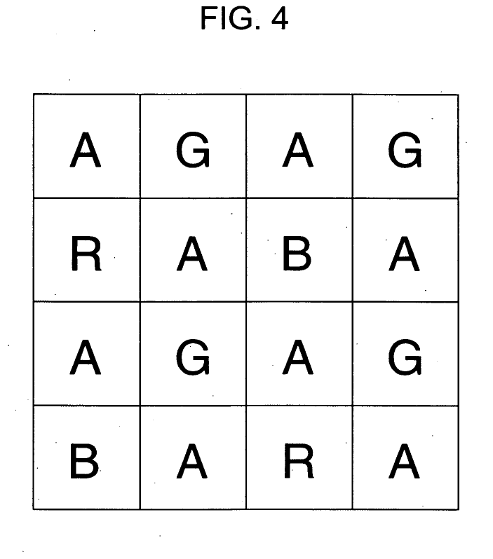

First, a description will be given to the configuration of an imaging device (hereinafter, referred to as imager) applied to an imaging apparatus of the present invention. The imaging apparatus of the present invention has a configuration that is basically similar to the one described above with reference to FIG. 2, but the imager applied to the imaging apparatus has a configuration different from the Bayer color array described with reference to FIG. 1. The configuration of the imager applied to the imaging apparatus of the present invention is described with reference to FIG. 4. The general solid state imager of the single plate color system has been described above with reference to FIG. 1. The general solid state imager of the single plate color system has stuck thereto a color filter transmitting only a specific wavelength component in each pixel to the surface of the imager, and restores necessary color components by a set of a plurality of pixels. In this case, the Bayer color array expressing red (R), green (G) and blue (B) by means of a set of four pixels as shown in FIG. 1, for example, is used as the color array used in the color filter.

The imager applied to the imaging apparatus of the present invention includes a color array shown in FIG. 4. That is, the imager is composed of a color filter including the following four kinds of spectral characteristics: red (R) transmitting the wavelengths near a red color, green (G) transmitting the wavelengths near a green color, blue (B) transmitting the wavelengths near a blue color, and A transmitting all of the infrared rays (IR), R, G and B in addition to the former three colors. The four kinds of spectra are composed of an R channel, a G channel, a B channel and an A channel transmitting all of the infrared rays (IR), the R, the G and the B, and a mosaic image composed of the four kinds of spectra can be obtained by means of the imager.

By way of example, A is a signal which contains both of a luminance signal (Y) of a visible light portion and an infrared light signal (IR), and which can be expressed as follows,
A=Y +IR.

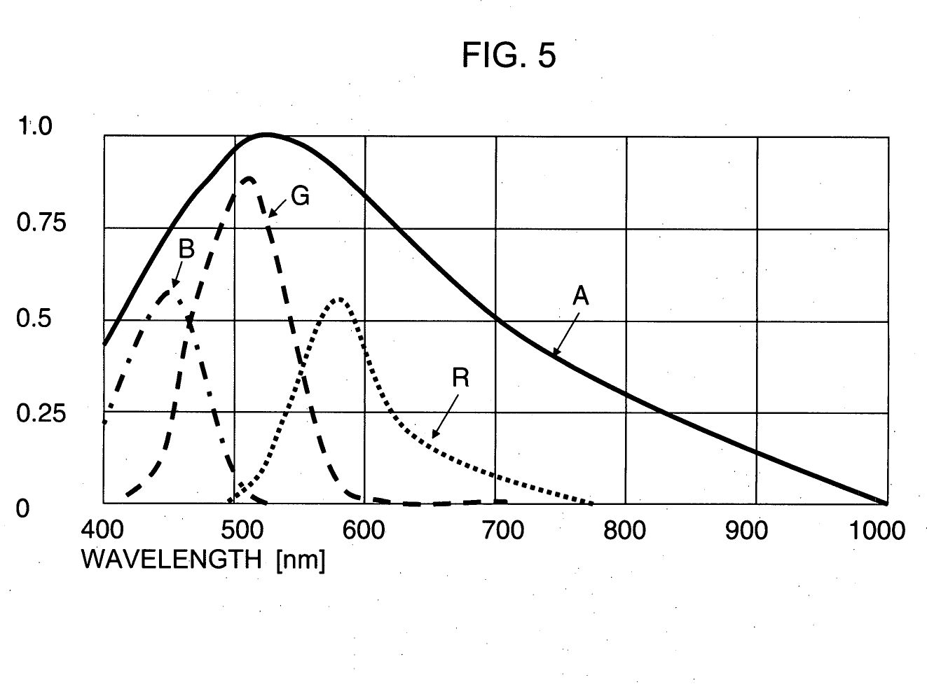

Spectral characteristics of the four kinds of filters will be described by referring to FIG. 5. A filter corresponding to B channel is a filter having a high transmittance to a light signal of approximately 200 nm to 300 nm wavelengths corresponding to a blue color; a filter corresponding to G channel is a filter having a high transmittance to a light signal of approximately 450 nm to 550 nm wavelengths corresponding to a green color; and a filter corresponding to R channel is a filter having a high transmittance to a light signal of approximately 550 nm to 650 nm wavelengths corresponding to a red color. These filters corresponding to RGB colors have such a characteristic that does not allow passage of most of an infrared component having a wavelength approximately 700 nm or more.

On the other hand, a filter corresponding to the A-channel has such a property, as shown in FIG. 5, to transmit all signals of RGB components as well as an infrared component in excess of 700 nm, although its peak resides in the vicinity of approximately 530 nm.

As described hereinabove, the imager according to the embodiment of the present invention is a single-plate imager having element arrays configured to include a specific wavelength range signal acquisition element (RGB-element) for acquiring a visible light signal corresponding to a specific light wavelength range such as RGB, and a wide wavelength range signal acquisition element (A-element) for acquiring a light signal which contains a visible light component such as RGB and an invisible light component such as an infrared light.

The imager to be applied to the imaging apparatus according to the embodiment of the present invention is an imager having the above-mentioned four kinds of transmitting filters corresponding to RGBA, and is provided as shown in FIG. 4 as a single-plate color imager having color arrays including an RGB-element for separately acquiring a color component signal RGB and the A-element for acquiring the A-signal containing RGB signal components as well as an infrared light component.

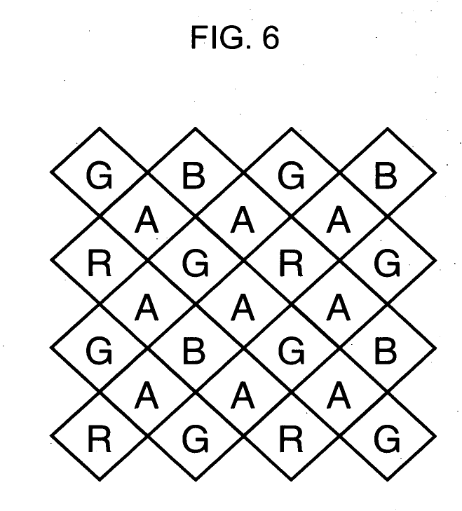

By way of example, the layout of RGBA color filter arrays is not limited to that shown in FIG. 4, and it may take another layout of array as shown in FIG. 6. Layout of arrays of optical filters shown in FIG. 6 corresponds to that obtained by rotating the arrays of FIG. 4 by 45 degrees.

Both in FIGS. 4 and 6, the A-signal acquisition elements are disposed in a checkered pattern. In an imaging apparatus according to the present invention, signal processing is performed basically on the basis of image data captured with such an imager as shown in FIG. 4 or 6, thereby enabling to obtain a high-quality image having been effectively reduced of a noise even for an image captured in a low illumination environment.

[2. First Image Signal Processing Example]

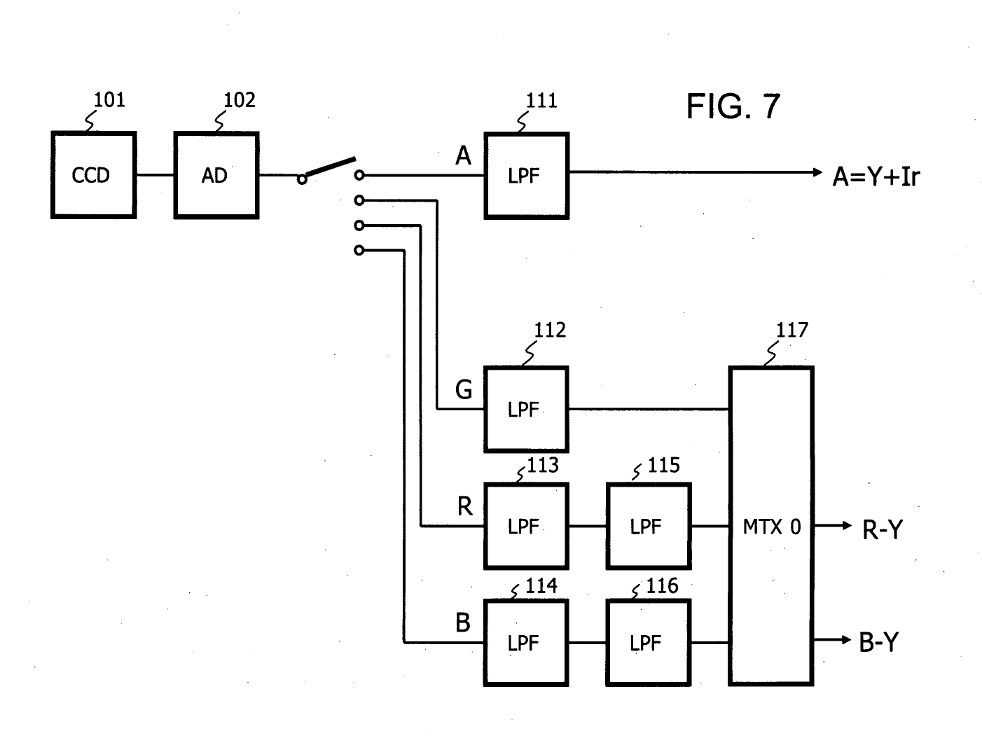

Subsequently, a first specific example of signal processing based on the image data captured with an imager as shown in FIG. 4 or 6 will be described by referring to FIG. 7. This processing example describes an exemplary case how a noise reduction processing for an image which contains much noise as captured, for example, in a dim light is performed on the basis of data of an image captured by applying the imager shown in FIG. 4 or 6.

FIG. 7 is a block diagram showing a signal processing configuration for obtaining a luminance signal (Y) and two color difference signals (R-Y) and (B-Y) through signal processing of images captured in an imager (CCD) 101 having RGBA arrays as shown in FIG. 4 or 6. By the way, to the data acquired with the imager, such processing as white balance adjustment or the like is applied, however, because these processing is the same as in related arts, they are not indicated in FIG. 7.

The configuration shown in FIG. 7 includes a luminance signal producing unit and a color difference signal producing unit. The luminance signal producing unit acquires a mosaic image which is a signal acquired by an A-element from signals acquired by an imager (CCD) having RGBA arrays as shown in FIG. 4 or 6, and produces, as its luminance signal, an A-demosaic image corresponding to a wide wavelength range signal. The color difference signal producing unit obtains an RGB-mosaic image which is a signal acquired by an RGB-element, produces an RGB-demosaic image corresponding to a visible light range signal, and produces a color difference signal based on the RGB-demosaic image. With reference to FIG. 7, a low-pass filter 111 corresponds to the luminance signal producing unit, and low-pass filters 112 to 116 and a matrix operation unit 117 correspond to the color difference producing unit.

A signal processing employing the configuration of FIG. 7 will be described. Signals captured in an imager (CCD) 101 which has RGBA arrays as shown in FIG. 4 or 6 are converted to digital data in an AD converter 102. Signals converted therein produce four mosaic images each corresponding to each of RGBA.

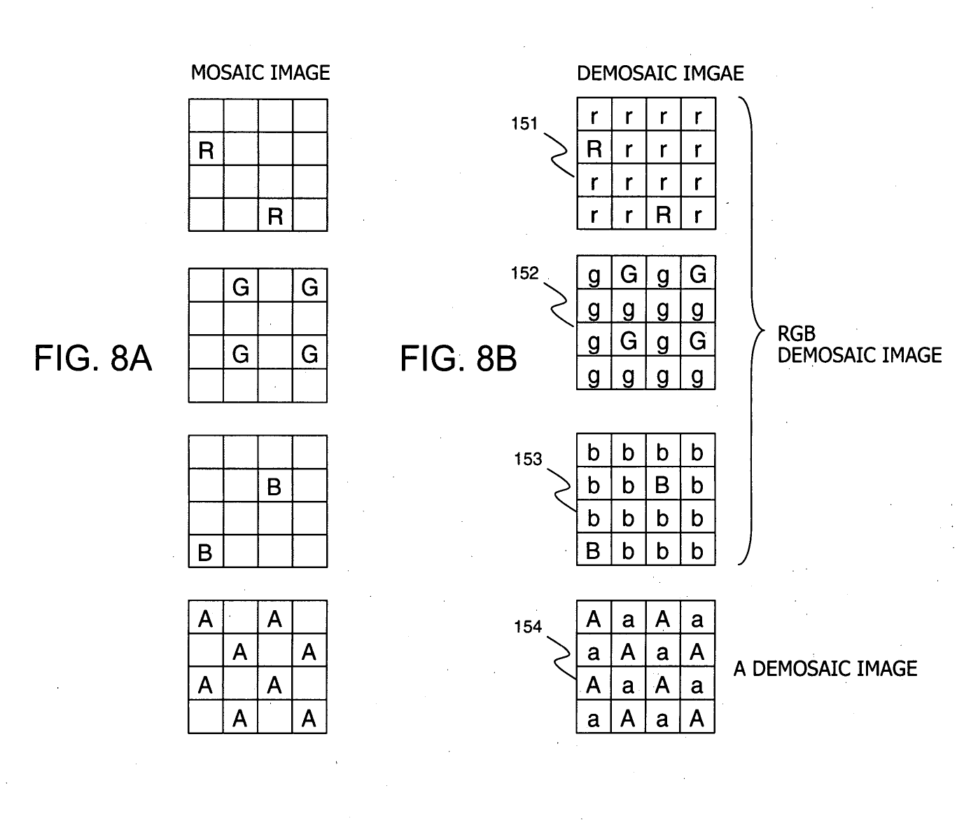

For example, in a case where the imager having the color arrays explained by referring to FIG. 4 is applied, four mosaic images corresponding to each of RGBA are acquired as shown in FIG. 8A. These four mosaic images are inputted to low-pass filters 111 to 116, respectively, in which interpolation processing so as to set up a pixel value to every pixel is performed by interpolating blank pixel portions without a pixel value with pixel values in the neighborhood, and thus a demosaic processing is performed.

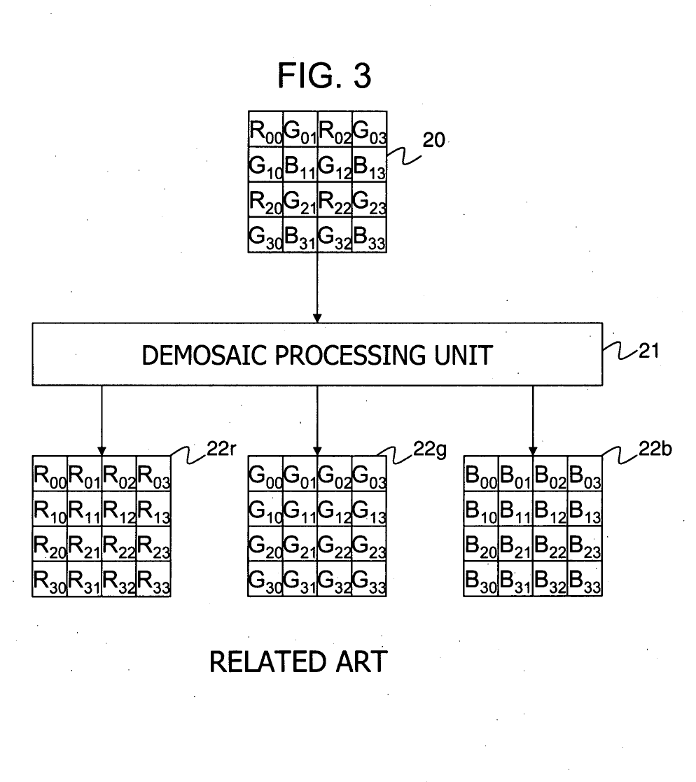

The demosaic processing is performed, as described with reference to FIG. 3, by interpolating a blank value pixel having no pixel value with surrounding pixel values so as to fill every pixel with a pixel value. For example, a method similar to the well-known Vargra algorithm can be applied. The Vargra algorithm is an algorithm that performs the demosaic processing by obtaining the gradients of pixel values in eight directions to average the pixel values the gradients of which are close to one another.

This demosaic processing determines a pixel value for a portion of pixels having no pixel value on the basis of pixel values of its surrounding pixels. This process is performed with a so-called two-dimensional FIR filter. Namely, a filter having a coefficient corresponding to a pixel position is employed. It is noted that, a two-stage low-pass filter is employed for R and B, and after processing in low-pass filters 113, 114 as an interpolating filter corresponding to offset sub-sampling, setting of pixel values in every pixel is performed via a low-pass filter 115, 116 similar to the low-pass filter 112.

Through this interpolation processing, demosaic images, for example, as shown in FIG. 8B are obtained. Here, a demosaic image 151 corresponds to an R-channel demosaic image produced by interpolation processing in the low-pass filters 113 and 115 shown in FIG. 7. A demosaic image 152 corresponds to a G-channel demosaic image produced by interpolation processing in the low-pass filter 112 shown in FIG. 7. A demosaic image 153 corresponds to a B-channel demosaic image produced by interpolation processing in the low-pass filters 114 and 116 shown in FIG. 7. And, a demosaic image 154 corresponds to an A-channel demosaic image produced by interpolation processing in the low-pass filter 111 shown in FIG. 7.

“R”, “G”, “B”, “A” in the four demosaic images in FIG. 8B are pixel values obtained directly from the mosaic images in FIG. 8A, and “r”, “g”, “b”, “a” therein indicate interpolated pixel values obtained via the demosaic processing.

In a demosaic image 154 in FIG. 8B, which is produced by the interpolating processing in low-pass filter 111 shown in FIG. 7, a pixel value set at each pixel therein corresponds to an intensity of light of A-channel, i.e., inclusive of a visible light wavelength range such as GBR and an infrared wavelength range. This demosaic image is obtained as an output from the low-pass filter 111 shown in FIG. 7, and its signal A is expressed as follows:
A =Y +IR.
As described with reference to FIG. 5, since the A-signal contains from a visible light range to an infrared light range, it is able to output a demosaic image containing substantially broader wavelength ranges of light components.

On the other hand, respective demosaic images corresponding to each of RGB produced in the low-pass filters 112 through 116, namely, the demosaic images 151 to 153 shown in FIG. 8B are inputted to a matrix operation unit 117 shown in FIG. 7, in which color difference signals (R-Y) and (B-Y) are computed by matrix operation based on respective RGB signals, and outputted therefrom.

In a case where a luminance signal and a color difference signal are obtained using a conventional imager having a Bayer array (YGBR) described with reference to FIG. 1B and applying a signal processing circuit as shown in FIG. 7, its luminance signal will be such one that contains only a visible light range wavelength component Y. However, by applying an imager having RGBA color arrays as shown in FIG. 4 or 6 according to the embodiment of the present invention, it becomes possible to obtain a demosaic image of A-channel containing wide wavelength range light components inclusive of a visible light as well as an infrared light, thereby allowing it to be used as a luminance signal [A=Y+IR].

AS described hereinabove, by allowing to include an infrared light component into-its luminance component, even in an image data captured in a low-illumination environment where at least a level difference of an infrared light component is detectable, each pixel value at each pixel in a demosaic image corresponding to A-channel is ensured to be a data that reflects the level difference of the infrared light component, thereby enabling to improve an S/N ratio of the image data captured in a low-illumination environment. This configuration is suitable for application, for example, to a monitor camera and the like where, although high reproducibility of colors is not required, an improved sensitivity and a high S/N ratio are demanded.

[3. Second Image Signal Processing Example]

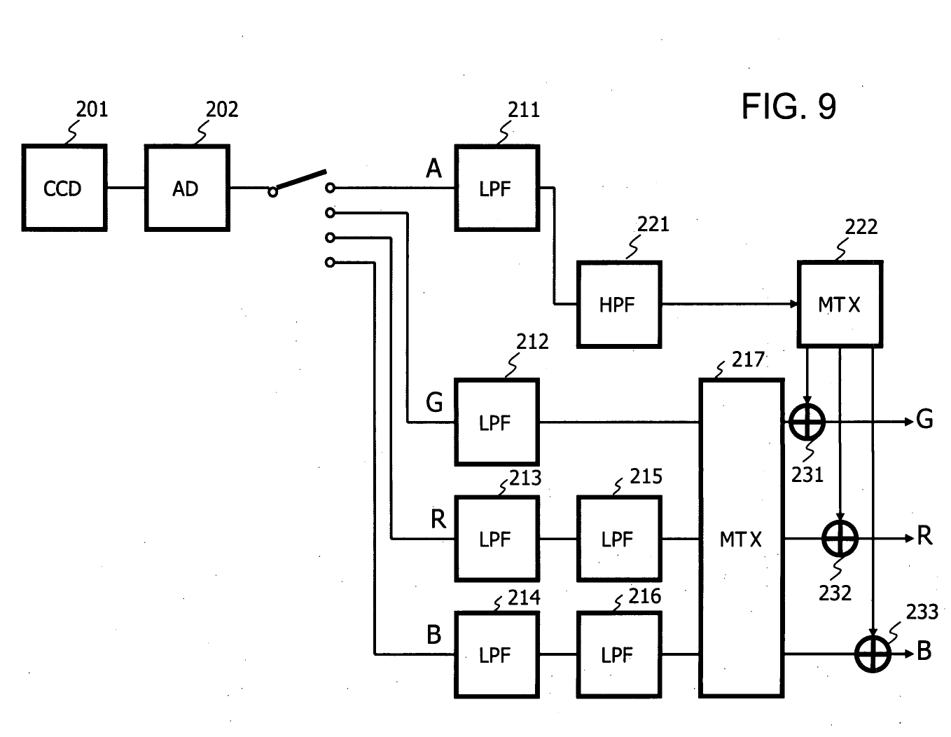

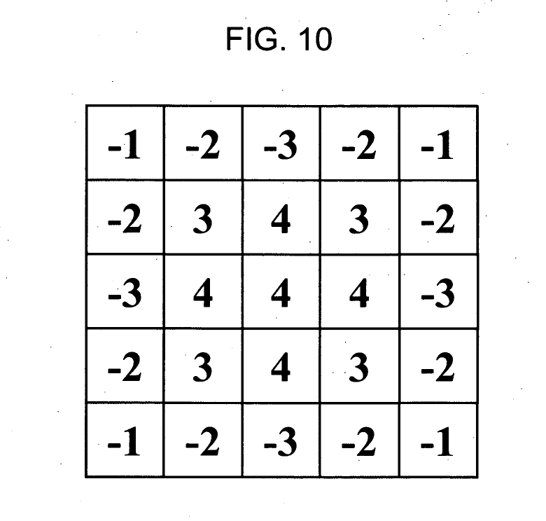

A second specific example of image signal processing according to an embodiment of the present invention will be described by referring to FIGS. 9 and 10. The signal processing circuit described by referring to FIG. 7 may have a difficulty in that, because its luminance component contains an infrared light, making its color reproducibility as the same level as that obtained in such a configuration that performs a color analysis processing solely on the basis of visible light data. A signal processing configuration according to the second example to be described in the following overcomes the difficulty and substantially improves the color reproducibility.

A configuration of the second image signal processing example will be described by referring to FIG. 9. Similarly to the first processing embodiment described above, this processing example performs signal processing of the images captured with an imager (CCD) 201 having RGBA arrays shown in FIG. 4 or 6. In this processing, color signals of RGB are outputted. It is noted that, in a circuitry shown in FIG. 9, the same processing such as white balancing adjustment or the like is performed as in the first processing example although not indicated in the drawing.

The configuration shown in FIG. 9 includes a first color component signal extraction unit, a second color component signal extraction unit, and a synthesizing process unit. The first color component signal extraction unit receives input of a mosaic image which is a signal acquired by an A-element from signals acquired by an imager (CCD) 201 having RGBA arrays as shown in FIG. 4 or 6, and extracts a visible light color component signal from an A-demosaic image corresponding to a wide wavelength range signal. The second color component signal extraction unit receives input of an RGB mosaic image which is a signal acquired by an RGB-element, produces an RGB demosaic image corresponding to a visible light range signal, and extracts a color component signal based on the RGB demosaic images. The synthesizing process unit executes processing to synthesize the color component signal extracted in the first color component extraction unit and the color component signal extracted in the second color component extraction unit.

In the configuration shown in FIG. 9, a low-pass filter 211, a high-pass filter 221 and a matrix operation unit 222 correspond to the first color component 30 extraction unit; low-pass filters 212 to 216, and a matrix operation unit 217 correspond to the second color component extraction unit; and adders 231 to 233 correspond to the synthetic processing unit.

The low-pass filter 211 in the first color component signal extraction unit functions as a wide wavelength range signal demosaic image producing unit which receives input of an A-mosaic image of a signal acquired by a wide wavelength range signal acquisition element (A-element), and outputs a wide wavelength range signal demosaic image corresponding to a wide wavelength range signal. The high-pass filter 221 functions as a wide wavelength range signal high frequency component image producing unit which extracts a high frequency component from an A-demosaic image, and produces a wide wavelength range signal high frequency component image. The matrix operation unit 222 functions as a visible light color component signal extraction unit for extracting color component signals of visible light from the wide wavelength range signal high frequency image.

Signal processing employing the configuration shown in FIG. 9 will be described in the following. An image captured with the imager (CCD) 201 having RGBA arrays as shown in FIG. 4 or 6 is converted to a digital data in an AD converter 202. Signals produced here are four mosaic images corresponding to each of RGBA.

For example, in a case of an imager having color arrays shown in FIG. 4, four mosaic images each corresponding to each of RGBA are obtained as shown in FIG. 8A. These four mosaic images are inputted to low-pass filters 211 to 216 respectively, where an interpolating process to set a pixel value at every pixel is performed by interpolating a blank pixel portion without a pixel value with surrounding pixel values, thus performing a demosaic processing. These processing is the same as in the first processing example described with reference to FIG. 7.

Through the interpolation processing in the low-pass filters 211 to 216, demosaic images, for example, as shown in FIG. 8B are obtained. Here, a demosaic image 151 is a demosaic image of R-channel produced by an interpolation processing in the low-pass filters 213 and 215 shown in FIG. 9, a demosaic image 152 is a demosaic image of G-channel produced by an interpolation processing in the low-pass filter 212 shown in FIG. 9, and a demosaic image 153 is a demosaic image of B-channel produced by interpolation processing in the low-pass filters 241 and 216 shown in FIG. 9.

Data produced by interpolation processing in the low-pass filter 211 shown in FIG. 9 is a demosaic image 154 in FIG. 8, which corresponds to a demosaic image of A-channel. In this demosaic image, each pixel is labeled with each pixel value corresponding to an intensity of light of A-channel, i.e., inclusive both of a visible light wavelength range such as GBR and an infrared (IR) light wavelength range.

According to the second processing example of the present invention, this demosaic image of A-channel is inputted to a high-pass filter 221 so as to extract a high frequency component from the demosaic image of A-channel. This high-pass filter 221 is a filter having coefficients, for example, as shown in the equation 1 below, or coefficients shown in FIG. 10.

$$\frac{1}{2} [ \begin{matrix}0 & - 1 & 0 \\ - 1 & 4 & - 1 \\ 0 & - 1 & 1\end{matrix} ] \qquad Equation 1$$

The high-pass filter 221 is, for example, an FIT filter for extracting high frequency components. The high-pass filter 221 extracts a high frequency component from the demosaic image of A-channel, and produces an A-channel high frequency component extraction resultant image.

Further, this A-channel high frequency component extraction resultant image produced from the demosaic image of A-channel is inputted to a matrix operation unit 222. In the matrix operation unit 222, respective wavelength component data of RGB contained in the A-channel are extracted. As described hereinabove, because the A-channel contains wavelength range information of both of the visible light component and the infrared light component, respective wavelength component signals corresponding to RGB are also included therein. The matrix operation unit 222 extracts RGB components from the A-channel high frequency component extraction resultant image.

The matrix operation unit 222 has coefficients, for example, as indicated in the following equation 2.

$$\begin{matrix}Equation 2 \text{:} & \\ [ \begin{matrix}{R}_{hpf} \\ {G}_{hpf} \\ {B}_{hpf}\end{matrix} ] = [ \begin{matrix}0.299 & 0.597 & 0.114\end{matrix} ] {A}_{hbf} & \end{matrix}$$

In the above equation,
A_{hpf}: a pixel value (to input) of A-channel high frequency component extraction resultant image;
R_{hpf}: R signal (to output) extracted from the A-channel high frequency component extraction resultant image;
G_{hpf}: G signal (to output) extracted from the A-channel high frequency component extraction resultant image;
B_{hpf}: B signal (to output) extracted from the A-channel high frequency component extraction resultant image.
   The matrix operation unit 222 extracts respective components of RGB (R_{hpf}, G_{hpf}, B_{hpf}) on the basis of each pixel value [A_{hpf}] of each pixel constituting the A-channel high frequency component extraction resultant image.

On the other hand, RGB-demosaic images produced by interpolation processing in the low-pass filters 212 to 216 are inputted to a matrix operation unit 217 where matrix operation is carried out to selectively extract R, G and B signals contained in the RGB-demosaic images, and these RGB signals selectively extracted are outputted therefrom.

Then, in adders 231 to 233, respective RGB signals produced on the basis of the RGB demosaic images and outputted from the matrix operation unit 217, and respective RGB signals extracted from the high frequency component image of the A-demosaic image are added together, thereby generating respective RGB signals to be outputted as a final output signal.

In this image signal processing example, it is configured so that a high frequency component extract image is generated on the basis of the A-channel image which is acquired as a signal component image based on the wide wavelength range signals containing a visible light component as well as an infrared component, these respective RGB-signals are extracted from this high frequency component extract image, then these respective RGB-signals are added to RGB-signals which are extracted from RGB-demosaic images. By applying the high frequency component extract image based on the A-channel image containing wider wavelength range signal components, it becomes possible to obtain a high resolution image. Further, by acquiring RGB-signals from the A-channel image, and adding them to respective RGB signals extracted from RGB-demosaic images, it becomes possible to generate and output more precise RGB-signals, and improve color reproducibility.

While the invention has been particularly shown and described with reference to preferred embodiments thereof, it will be understood by those skilled in the art that various changes and modifications may be made without departing from the spirit and scope of the invention. Therefore, the scope of the present invention is to be determined by the appended claims.

Further, a series of processing and procedures described in the specification of the invention is able to be implemented or executed by means of hardware, software or a combination thereof. When executing the processing with software, a program recording the process sequences is installed in a memory in a computer incorporated in a dedicated hardware, or it may be installed in a general purpose computer capable of executing versatile processing.

For example, the program can be recorded in advance into a hard disk or a read only memory (ROM) as a recording medium. Alternatively, the program can be temporarily or eternally stored (recorded) into a removable recording medium such as a flexible disk, a compact disc read only memory (CD-ROM), a magneto optical (MO) disk, a digital versatile disc (DVD), a magnetic disc, a semiconductor memory or the like. Such a removable recording medium can be provided as the so-called package software.

Further, besides installing the program in a computer from the above-mentioned removable recording medium, it may be transmitted also by downloading from a download site to a computer via wireless transmission or wired transmission via a network such as LAN (Local Area Network), internet or the like, and the computer having received a transmitted program installs it in a built-in recording medium such as a hard disk.

By way of example, various process sequences and procedures described in the specification of the present invention may be executed not only in the time sequences as described therein but also in parallel or separately depending on a processing capability of a system to be used or as required. Further, the term of system used in this specification refers to a logically assembled configuration of a plurality of equipment to perform a specific function, and it is not limited to that the plurality of equipment be encased in the same housing.

As described heretofore, according to the configuration of the embodiment of the present invention, because it is configured that, on the basis of the mosaic image data of respective signals acquired by the single-plate imager having element arrays including a specific wavelength range signal acquisition element for acquiring a visible light signal such as an RGB signal and a wide wavelength range signal acquisition element for acquiring a light signal containing a visible light component as well as an invisible light component such as an infrared light, there are generated the luminance signal containing the infrared component, color difference signals and respective color signals of RGB, it is possible to obtain a high resolution and high quality image even for an image captured in a low-illumination environment, and further by applying color adjustments based on the A-channel image which has both RGB components and infrared components, it is possible to produce an improved image having a high color reproducibility.

It should be understood by those skilled in the art that various modifications, combinations, sub-combinations and alterations may occur depending on design requirements and other factors insofar as they are within the scope of the appended-claims or the equivalents thereof.

### CROSS REFERENCES TO RELATED APPLICATIONS

The present document contains subject matter related to Japanese Patent Application JP 2005-369379 filed in the Japanese Patent Office on Dec. 22, 2005, the entire contents of which being incorporated herein by reference.

What is claimed is:

1. An image signal processing apparatus comprising:
a luminance signal producing unit which receives input of a mosaic image of a signal acquired by a wide wavelength range signal acquisition element from signals acquired by a single-plate imaging device having element arrays including a specific wavelength range signal acquisition element for acquiring a visible light signal corresponding to a specific light wavelength range and the wide wavelength range signal acquisition element for acquiring a light signal containing a visible light component and an invisible light component, and produces, as a luminance signal, a wide wavelength range signal demosaic image corresponding to a wide wavelength range signal; and
a color difference signal producing unit which receives input of a mosaic image of a signal acquired by the specific wavelength range signal acquisition element, produces a visible light range signal demosaic image corresponding to a visible light range signal, then produces a color difference signal based on the visible light range signal demosaic image.

2. The image signal processing apparatus as claimed in claim 1, wherein:
the specific wavelength range signal acquisition element is an RGB-element for separately acquiring a color component signal RGB,
the wide wavelength range signal acquisition element is an A-element for acquiring an A-signal which contains RGB color signal components and an infrared light component,
the luminance signal producing unit is configured to receive input of an A mosaic image which is a signal acquired by the A element for acquiring the A signal, and produces, as a luminance signal, an A-demosaic image which contains the RGB color signal components and the infrared light component; and
the color difference signal producing unit is configured to receive input of an RGB-mosaic image acquired by the RGB elements, produces an RGB-demosaic image, then produces a color difference signal based on the RGB-demosaic images.

3. The image signal processing apparatus as claimed in claim 2, wherein:
the color difference signal producing unit is configured to perform a processing to produce color difference signals R-Y and B-Y based on the RGB-demosaic image.

4. An image signal processing apparatus comprising:
a first color component signal extracting unit which receives input of a mosaic image of a signal acquired by a wide wavelength range signal acquisition element from signals acquired by a single-plate imaging device having element arrays including a specific wavelength range signal acquisition element for acquiring a visible light signal corresponding to a specific light wavelength range and the wide wavelength range signal acquisition element for acquiring a light signal containing a visible light component and an invisible light component, and extracts a visible light color component signal from a wide wavelength range signal demosaic image corresponding to a wide wavelength range signal;
a second color component signal extracting unit which receives input of a mosaic image of a signal acquired by the specific wavelength range signal acquisition element, produces a visible light range signal demosaic image corresponding to the visible light range signal, and extracts a color component signal on the basis of the visible light range signal demosaic image; and
a synthesizing unit for performing a processing to synthesize the visible light color component signal extracted in the first color component extracting unit and the color component signal extracted in the second color component extracting unit.

5. The image signal processing apparatus as claimed in claim 4, wherein:
the first color component signal extracting unit includes:
a wide wavelength range signal demosaic image producing unit which receives input of a mosaic image of a signal acquired by the wide wavelength range signal acquisition element, and produces the wide wavelength range signal demosaic image corresponding to the wide wavelength range signal;
a wide wavelength range signal high frequency component image producing unit which extracts a high frequency component from the wide wavelength range signal demosaic image, and produces a wide wavelength range signal high frequency component image; and
a visible light color component signal extracting unit which extracts the visible light color component signal from the wide wavelength range signal high frequency component image.

6. The image signal processing apparatus as claimed in claim 4, wherein:
the specific wavelength range signal acquisition element is an RGB-element for separately acquiring a color component signal RGB,
the wide wavelength range signal acquisition element is an A-element for acquiring an A-signal which contains RGB color signal components and an infrared light component,
the first color component extracting unit is configured to receive input of a mosaic image of a signal acquired by the A element, and extract a visible light color component signal RGB from an A-signal demosaic image;
the second color component extracting unit is configured to receive input of an RGB-mosaic image of a signal acquired by the RGB element, produces an RGB-demosaic image, and extracts a color component signal RGB on the basis of the RGB demosaic image; and
the synthesizing unit is configured to execute processing to synthesize the visible light color component signal RGB extracted in the first color component extracting unit and the color component signal RGB extracted in the second color component extracting unit.

7. An imaging device having element arrays comprising:
a specific wavelength range signal acquisition element for acquiring a visible light signal corresponding to a specific light wavelength range; and
a wide wavelength range signal acquisition element for acquiring a light signal containing a visible light component and an invisible light component.

8. The imaging device as claimed in claim 7, wherein:
the specific wavelength range signal acquisition element is an RGB-element for separately acquiring a color component signal RGB; and
the wide wavelength range signal acquisition element is an A-element for acquiring an A-signal which contains an RGB color signal component and an infrared light component.

9. The imaging device as claimed in claim 7, wherein:
the wide wavelength range signal acquisition element is configured to be disposed in a checkered-pattern.

10. An imaging apparatus comprising:
a single-plate imaging device having element arrays including a specific wavelength range signal acquisition element for acquiring a visible light signal corresponding to a specific light wavelength range and a wide wavelength range signal acquisition element for acquiring a light signal containing a visible light component and an invisible light component;
a luminance signal producing unit which receives input of a mosaic image of a signal acquired by the wide wavelength range signal acquisition element from signals acquired by the single-plate imaging device, and produces, as a luminance signal, a wide wavelength range signal demosaic image corresponding to a wide wavelength range signal; and
a color difference signal producing unit which receives input of a mosaic image of a signal acquired by the specific wavelength range signal acquisition element, produces a visible light range signal demosaic image then produces a color difference signal based on the visible light range signal demosaic image.

11. The imaging apparatus as claimed in claim 10, wherein:
the specific wavelength range signal acquisition element is an RGB-element for separately acquiring a color component signal RGB,
the wide wavelength range signal acquisition element is an A-element for acquiring an A-signal which contains an RGB color signal component and an infrared light component,
the luminance signal producing unit is configured to receive input of an A-mosaic image of a signal acquired by the A-element, and produces, as a luminance signal, an A signal demosaic image which contains the RGB color signal component and the infrared light component, and
the color difference signal producing unit is configured to receive input of an RGB-mosaic image of a signal acquired by the RGB-element, produces an RGB-demosaic image, then produces a color difference signal based on the RGB-demosaic image.

12. The imaging apparatus as claimed in claim 11, wherein:
the color difference signal producing unit is configured to execute a process to produce color difference signals R-Y and B-Y based on the RGB-demosaic images.

13. An imaging apparatus comprising:
a single-plate imaging device having element arrays which include a specific wavelength range signal acquisition element for acquiring a visible light signal corresponding to a specific light wavelength range and a wide wavelength range signal acquisition element for acquiring a light signal containing a visible light component and an invisible light component;
a first color component signal extracting unit which receives input of a mosaic image of a signal acquired by the wide wavelength range signal acquisition element from signals acquired by the single-plate imaging device, and extracts a visible light color component signal from a wide wavelength range signal demosaic image corresponding to a wide wavelength range signal;
a second color component signal extracting unit which receives input of a mosaic image of a signal acquired by the specific wavelength range signal acquisition element, produces a visible light range signal demosaic image corresponding to a visible light range signal, and extracts a color component signal on the basis of the visible light range signal demosaic image; and
a synthesizing unit for performing a processing to synthesize the visible light color component signal extracted in the first color component extracting unit and the color component signal extracted in the second color component extracting unit.

14. The imaging apparatus as claimed in claim 13, wherein:
the first color component signal extracting unit is configured to have:
a wide wavelength range signal demosaic image producing unit which receives input of a mosaic image of the signal acquired by the wide wavelength range signal acquisition element, and produces the wide wavelength range signal demosaic image corresponding to the wide wavelength range signal;
a wide wavelength range signal high frequency component image producing unit which extracts a high frequency component from the wide wavelength range signal demosaic image, and produces a wide wavelength range signal high frequency component image; and
a visible light color component signal extracting unit which extracts the visible light color component signal from the wide wavelength range signal high frequency component image.

15. The imaging apparatus as claimed in claim 13, wherein:
the specific wavelength range signal acquisition element is an RGB-element for separately acquiring a color component signal RGB,
the wide wavelength range signal acquisition element is an A-element for acquiring an A-signal which contains an RGB-color signal component and an infrared light component,
the first color component signal extracting unit is configured to receive input of a mosaic image of the signal acquired by the A-element, and extract the visible light color component signal RGB from an A-signal demosaic image,
the second color component signal extracting unit is configured to receive input of an RGB-mosaic image of the signal acquired by the RGB-element, produce an RGB-demosaic image, and extract a color component signal RGB based on the RGB-demosaic image, and the synthesizing unit synthesizes the visible light color component signal RGB extracted in the first color component extracting unit and the color component signal RGB extracted in the second color component extracting unit.

16. An image signal processing method comprising:
a luminance signal producing step of receiving input of a mosaic image of a signal acquired by a wide wavelength range signal acquisition element from signals acquired by a single-plate imaging device having element arrays including a specific wavelength range signal acquisition element for acquiring a visible light signal corresponding to a specific light wavelength range and the wide wavelength range signal acquisition element for acquiring a light signal which contains a visible light component and an invisible light component, and producing, as a luminance signal, a wide wavelength range signal demosaic image corresponding to a wide wavelength range signal; and
a color difference signal producing step of inputting a mosaic image of a signal acquired by the specific wavelength range signal acquisition element, producing a visible light range signal demosaic image corresponding to a visible light range signal, then producing a color difference signal based on the visible light range signal demosaic image.

17. The image signal processing method as claimed in claim 16, wherein:
the specific wavelength range signal acquisition element is an RGB-element for separately acquiring a color component signal RGB,
the wide wavelength range signal acquisition element is an A-element for acquiring an A-signal which contains an RGB-color signal component and an infrared light component,
the luminance signal producing step is a step of receiving input of an A-mosaic image which is a signal acquired by the A-element, and producing, as a luminance signal, an A-signal demosaic image which contains the RGB color signal component and the infrared light component; and
the color difference signal producing step is a step of receiving input of an RGB-mosaic image of a signal acquired by the RGB-element, producing an RGB-demosaic image, then producing the color difference signal based on the RGB-demosaic image.

18. The image signal processing method as claimed in claim 17, wherein:
the color difference signal producing step is a step of producing color difference signals R-Y and B-Y on the basis of the RGB-demosaic image.

19. An image signal processing method comprising:
a first color component signal extracting step of receiving input of a mosaic image of a signal acquired by a wide wavelength range signal acquisition element from signals acquired by a single-plate imaging device having element arrays including a specific wavelength signal acquisition element for acquiring a visible light signal corresponding to a specific light wavelength range and the wide wavelength range signal acquisition element for acquiring a light signal containing a visible light component and an invisible light component, and extracting a visible light color component signal from a wide wavelength range signal demosaic image corresponding to a wide wavelength range signal;
a second color component signal extracting step of receiving input of a mosaic image of a signal acquired by the specific wavelength range signal acquisition element, producing a visible light range signal demosaic image corresponding to a visible light range signal, and extracting a color component signal on the basis of the visible light range signal demosaic image; and
a synthesizing step of synthesizing the visible light color component signal extracted in the first color component extracting step and the color component signal extracted in the second color component extracting step.

20. The image signal processing method as claimed in claim 19, wherein:
the first color component signal extracting step includes:
a wide wavelength range signal demosaic image producing step of receiving input of a mosaic image of a signal acquired by the wide wavelength range signal acquisition element to produce a wide wavelength range signal demosaic image corresponding to a wide wavelength range signal;
a wide wavelength range signal high frequency component image producing step of extracting a high frequency component from the wide wavelength range signal demosaic image to produce a wide wavelength range signal high frequency component image; and
a visible light color component signal extracting step of extracting a visible light color component signal from the wide wavelength range signal high frequency component image.

21. The image signal processing method as claimed in claim 19, wherein:
the specific wavelength range signal acquisition element is an RGB-element for separately acquiring a color component signal RGB, the wide wavelength range signal acquisition element is an A-element for acquiring an A-signal which contains an RGB-color signal component and an infrared light component,
the first color component signal extracting step is a step of receiving input of a mosaic image of an A-signal acquired by the A-element, and extracting a visible light color component signal RGB from an A-signal demosaic image,
the second color component signal extracting step is a step of receiving input of an RGB-mosaic image of a signal acquired by the RGB-element, producing an RGB-demosaic image, and extracting a color component signal RGB on the basis of the RGB-demosaic image, and the synthesizing step is a step of synthesizing the visible light color component signal RGB extracted in the first color component extracting step and the color component signal RGB extracted in the second color component extracting step.

22. A computer program for executing an image signal processing in an image signal processing apparatus, the computer program comprising:
a luminance signal producing step of receiving input of a mosaic image of a signal acquired by a wide wavelength range signal acquisition element from signals acquired by a single-plate imaging device having element arrays including a specific wavelength range signal acquisition element for acquiring a visible light signal corresponding to a specific light wavelength range and the wide wavelength range signal acquisition element for acquiring a light signal containing a visible light component and an invisible light component, and producing as a luminance signal, a wide wavelength range signal demosaic image corresponding to a wide wavelength range signal; and
a color difference signal producing step of receiving input of a mosaic image of a signal acquired by the specific wavelength range signal acquisition element, producing a visible light range signal demosaic image corresponding to a visible light range signal, and producing a color difference signal on the basis of the visible light range signal demosaic image.

23. A computer program for executing an image signal processing in an image signal processing apparatus, the computer program comprising:
a first color component signal extracting step of receiving input of a mosaic image of a signal acquired by a wide wavelength range signal acquisition element from signals acquired by a single-plate imaging device having element arrays including a specific wavelength range signal acquisition element for acquiring a visible light signal corresponding to a specific light wavelength and the wide wavelength range signal acquisition element for acquiring a light signal containing a visible light component and an invisible light component, and extracting a visible light color component signal from a wide wavelength range signal demosaic image corresponding to a wide wavelength range signal;
a second color component signal extracting step of receiving input of a mosaic image of a signal acquired by the specific wavelength range signal acquisition element, producing a visible light range signal demosaic image corresponding to a visible light range signal, and extracting a color component signal on the basis of the visible light range signal demosaic image; and
a synthesizing step of synthesizing the visible light color component signal extracted in the first color component extracting step and the color component signal extracted in the second color component extracting step.
